(19) United States
(12) Patent Application Publication
(10) Pub. No.: US 2025/0219088 A1
(43) Pub. Date: Jul. 3, 2025

(54) ALL-SOLID-STATE BATTERY ELECTRODE AND ALL-SOLID-STATE BATTERY

(71) Applicant: Maxell, Ltd., Otokuni-gun, Kyoto (JP)

(72) Inventors: Kentaro TOMITA, Otokuni-gun, Kyoto (JP); Haruki KAMIZORI, Otokuni-gun, Kyoto (JP)

(73) Assignee: Maxell, Ltd., Otokuni-gun, Kyoto (JP)

(21) Appl. No.: 18/850,347

(22) PCT Filed: Mar. 20, 2023
(86) PCT No.: PCT/JP2023/010874

§ 371 Date: Sep. 24, 2024

(30) Foreign Application Priority Data
Mar. 31, 2022 (JP) 2022-059434

(51) Int. Cl. H01M 4/62; H01M 4/02; H01M 4/485; H01M 10/0525; H01M 10/0562

(52) U.S. Cl. CPC H01M 4/625; H01M 4/485; H01M 10/0525; H01M 10/0562; H01M 2004/021

(57) ABSTRACT

An all-solid-state battery electrode of the present invention includes: a molded body formed from an electrode mixture that contains at least an electrode active material, a solid electrolyte, and conductive assistant particles. The conductive assistant particles have an aspect ratio A determined by observing a cross section of the molded body of the electrode mixture of 1.5 or more, and an inter-particle distance L (μm) of the conductive assistant particles in a three-dimensional space and a length b (μm) of a long axis of the conductive assistant particles, which are determined by observing the cross section, satisfy the following relationship: L≤b. The all-solid-state battery of the present invention includes the all-solid-state battery electrode of the present invention as a positive electrode and/or a negative electrode.

### TECHNICAL FIELD

The present invention relates an all-solid-state battery that has a large capacity and excellent output characteristics, and an electrode that can constitute the all-solid-state battery.

### BACKGROUND ART

Non-aqueous electrolyte secondary batteries are used in power supply applications for portable electronic devices such as cellular phones and laptop computers, electric vehicles, and the like. Providing non-aqueous electrolyte secondary batteries to society will contribute to reaching the following goals of the 17 Sustainable Development Goals (SDGs) established by the United Nations: Goal 3 (to ensure healthy lives and promote well-being for all people of all ages), Goal 7 (to ensure access for all people to affordable, reliable, sustainable and modern energy), Goal 11 (to achieve inclusive, safe, resilient and sustainable cities and human settlements), and Goal 12 (to ensure sustainable production and consumption patterns).

In currently available non-aqueous electrolyte secondary batteries, usually, a lithium-containing composite oxide is used as a positive electrode active material, and graphite or the like is used as a negative electrode active material.

Also, various studies have been conducted on non-aqueous electrolyte secondary batteries to improve their characteristics. For example, the aspect ratio of a conductive material portion in a cross section of an electrode has been disclosed (Patent Documents 1 and 2).

Furthermore, from the viewpoint of improving the reliability of non-aqueous electrolyte secondary batteries, attempts have been made to use a solid electrolyte instead of a non-aqueous electrolyte (a non-aqueous electrolyte solution) that contains an organic solvent which is a flammable substance (Patent Document 3 and the like).

### PRIOR ART DOCUMENTS

### Patent Document

Patent Document 1: WO 2018/168059
Patent Document 2: WO 2020/054615
Patent Document 3: JP 2021-141007A

### DISCLOSURE OF INVENTION

### Problem to be Solved by the Invention

Applications of non-aqueous electrolyte secondary batteries are expected to further expand in the future. Along with this, it is expected that non-aqueous electrolyte secondary batteries are required to have much higher output characteristics. In particular, applications of all-solid-state batteries that include an electrode that contains a solid electrolyte are rapidly expanding. Accordingly, there is a strong demand for improving the output characteristics of all-solid-state batteries.

The present invention has been accomplished in view of the circumstances described above, and it is an object of the present invention to provide an all-solid-state battery that has a large capacity and excellent output characteristics, and an electrode that can constitute the all-solid-state battery.

### Means for Solving Problem

An all-solid-state battery electrode according to the present invention includes: a molded body formed from an electrode mixture that contains an electrode active material, a solid electrolyte, and conductive assistant particles, wherein, where a number-based average particle size of the conductive assistant particles is represented by D(μm), a number-based average cross-sectional area of the conductive assistant particles is represented by s (μm²), an aspect ratio of the conductive assistant particles is represented by A, and an average inter-centroid distance of the conductive assistant particles is represented by 1(μm), which are determined by observing a cross section of the molded body of the electrode mixture, the conductive assistant particles satisfy A≥1.5, and an inter-particle distance L(μm) of the conductive assistant particles in a three-dimensional space calculated from (1.22×D×l²)^{1/3} and a length b (μm) of a long axis of the conductive assistant particles calculated from 1.27×(A×s/π)^{0.5} satisfy the following relationship: L S b.

Also, an all-solid-state battery according to the present invention includes: a positive electrode; a negative electrode; and a solid electrolyte layer interposed between the positive electrode and the negative electrode, wherein at least one of the positive electrode and the negative electrode is the all-solid-state battery electrode according to the present invention.

### Effects of the Invention

According to the present invention, it is possible to provide an all-solid-state battery that has a large capacity and excellent output characteristics, and an electrode that can constitute the all-solid-state battery.

### BRIEF DESCRIPTION OF DRAWINGS

FIG. 1 is a cross-sectional view schematically showing an example of an all-solid-state battery according to the present invention.

FIG. 2 is a plan view schematically showing another example of an all-solid-state battery according to the present invention.

FIG. 3 is a cross-sectional view taken along the line I-I shown in FIG. 2.

### DESCRIPTION OF THE INVENTION

### <All-Solid-State Battery Electrode>

An all-solid-state battery electrode according to the present invention (hereinafter also referred to simply as “electrode”) includes a molded body formed from an electrode mixture that contains at least an electrode active material, a solid electrolyte, and conductive assistant particles, the molded body being a layer (an electrode mixture layer) formed on a current collector using the electrode mixture, a molded body (a pellet or the like) formed by molding the electrode mixture, or the like.

In the electrode of the present invention, where a number-based average particle size of conductive assistant particles is represented by D(μm), a number-based average cross-sectional area of the conductive assistant particles is represented by s (μm²), an aspect ratio of the conductive assistant particles is represented by A, an inter-centroid distance is represented by l_{d}(μm), the inter-centroid distance l_{d} being an arithmetic average value of an euclidean distance l₁ between a centroid of a conductive assistant particle a and a centroid of a conductive assistant particle closest to the conductive assistant particle a, an euclidean distance l₂ between the centroid of the conductive assistant particle a and a centroid of a conductive assistant particle that is the second closest to the conductive assistant particle a, and an euclidean distance l₃ between the centroid of the conductive assistant particle a and a centroid of a conductive assistant particle that is the third closest to the conductive assistant particle a, and an average inter-centroid distance that is an arithmetic average value of the inter-centroid distance l_{d} is represented by 1(μm), which are determined by observing a cross section of the molded body of the electrode mixture, an inter-particle distance L (μm) of the conductive assistant particles in a three-dimensional space calculated from (1.22×D×l²)^{1/3} and a length b (μm) of a long axis of the conductive assistant particles calculated from 1.27×(A×s/π)^{0.5} satisfy the following relationship: L≤b.

The term “a long axis of the conductive assistant particles” used in the specification of the present application refers to an arithmetic average length of the long axis of an elliptic shape obtained by performing elliptic approximation on a cross section of each conductive assistant particle. The term “a short axis of the conductive assistant particles” used in the specification of the present application refers to an arithmetic average length of the short axis of an elliptic shape obtained by performing elliptic approximation on a cross section of each conductive assistant particle. The term “the aspect ratio A of the conductive assistant particles” used in the specification of the present application refers to an arithmetic average of the aspect ratio of an elliptic shape obtained by performing elliptic approximation on a cross section of each conductive assistant particle.

The inter-particle distance L of the conductive assistant particles in a three-dimensional space is based on the centroid of the conductive assistant particles. Accordingly, in the case where the length b of the long axis of the conductive assistant particles is the same as or longer than the inter-particle distance L, the conductive assistant particles can come into contact with each other to form a conductive path therebetween, and thus a favorable conductive network is formed in three-dimensional directions in the molded body of the electrode mixture. For this reason, in the electrode of the present invention, favorable electron conductivity is achieved in the molded body of the electrode mixture, and the utilization rate of the electrode active material increases, which increases the capacity and improves the output characteristics. Accordingly, an all-solid-state battery (an all-solid-state battery according to the present invention) constructed using the electrode of the present invention has a large capacity and excellent output characteristics.

In order to form a favorable conductive network in the molded body of the electrode mixture to improve the output characteristics of the electrode of the present invention and to hence improve the output characteristics of the all-solid-state battery constructed using the electrode of the present invention, the molded body of the electrode mixture is required to contain a certain amount of conductive assistant particles. However, on the other hand, when the molded body of the electrode mixture contains an excessively large amount of conductive assistant particles, the amount of the electrode active material is reduced, resulting in a reduced capacity, or the amount of the solid electrolyte is reduced, resulting in a poor balance between ion conductivity and electron conductivity. For this reason, it is desirable that the amount of the conductive assistant particles in the molded body of the electrode mixture is limited to some extent.

Accordingly; in the electrode of the present invention, S/Sₜₒₜ that is a ratio of a total cross-sectional area S (μm²) of the conductive assistant particles determined by observing a cross section of the molded body of the electrode mixture relative to an area Sₜₒₜ (μm²) of an observed range of the cross section is preferably 0.02 or more, and more preferably 0.03 or more, and preferably 0.1 or less, and more preferably 0.09 or less. In this case, it is possible to form a more favorable conductive network while limiting the amount of the conductive assistant particles in the molded body of the electrode mixture as much as possible.

The inter-particle distance L of the conductive assistant particles in a three-dimensional space is calculated from (1.22×D×l²)^{1/3}. The calculation is performed in the following manner.

The number-based average particle size (average diameter) of conductive assistant particles that can be seen in a cross-sectional image of the observed molded body of the electrode mixture is represented by D(μm), and the actual particle size is represented by d (μm). If it is assumed that the conductive assistant particles are randomly dispersed in the molded body of the electrode mixture, the average diameter D is equal to an average value of the diameter of a circular cutting plane formed by cutting a sphere, and the volume of the sphere is equal to the volume of a cylinder whose bottom is a circle that has the average diameter D and whose height is represented by d. From this,

$$( 4 / 3 ) \times Π \times ( d / 2 ) 3 = Π \times {( D / 2 )}^{2} \times d .$$

### Therefore,

$$d = {( 3 / 2 )}^{0.5} \times D \approx 1.22 D .$$

The number n of conductive assistant particles that can be seen in the cross-sectional image is equal to the number of particles present in a volume represented by a product of the cross-sectional area (the area of the observed field of view) Sₜₒₜ (μm²) and a depth corresponding to the particle size d (μm) of the conductive assistant particles. Accordingly, where the number concentration of the conductive assistant particles per unit volume is represented by N,

$$n = {S}_{tot} \times d \times N .$$

Therefore,

$$1 / N = d \times {S}_{t o t} / n . \qquad ( 3 )$$

The average area (μm²) per particle obtained by dividing the cross-sectional area Sₜₒₜ by the number n of conductive assistant particles present in the cross section (the field of view) is equal to the area of a square that has a side length equal to the average inter-centroid distance l (μm) of the conductive assistant particles when it is assumed that the conductive assistant particles are uniformly dispersed in the molded body of the electrode mixture. Therefore,

$${S}_{tot} / n = {1}^{2} . \qquad ( 4 )$$

Likewise, the inverse number of the average number (or in other words, number concentration) N of conductive assistant particles per unit volume is equal to the average value of the volume assigned per particle. This average value is equal to the volume of a cube that has a side length equal to the average inter-centroid distance L (μm) of the conductive assistant particles when it is assumed that the conductive assistant particles are uniformly dispersed in the molded body of the electrode mixture.

Therefore,

$$1 / N = {L}^{3} . \qquad ( 5 )$$

Accordingly, from the equation (3) and the equation (5),

$$L = {( 1 / N )}^{1 / 3} = {( d \times {S}_{t o t} / n )}^{1 / 3} ,$$

and since, from the equation (4),

$$L = {( d \times {1}^{2} )}^{1 / 3} ,$$

$$L = {( 1.22 \times D \times {1}^{2} )}^{1 / 3} .$$

Also, the length b of the long axis of the conductive assistant particles is calculated from 1.27×(A×s/π)^{0.5}. The calculation is performed in the following manner.

Assuming that each conductive assistant particle is a spheroidal sheet that has a thickness and an elliptic cross section, the average length b of the long axis of the spheroidal sheet (or in other words, the diameter of the spheroidal sheet) is determined. The average length of the long axis of the conductive assistant particles that can be seen in a cross-sectional image of the observed molded body of the electrode mixture is represented by x (μm). Here, if it is assumed that the conductive assistant particles are dispersed in parallel to each other and randomly in the molded body of the electrode mixture, the average long axis length x is equal to the average length of a chord of the spheroidal sheet obtained when the spheroidal sheet is cut at an arbitrary position, and the projected area of the spheroidal sheet as viewed from the rotation axis of the spheroidal sheet is equal to the area of a rectangle that has the average long axis length x and the diameter of the spheroidal sheet. Accordingly, using the average long axis length x and the actual average length b of the long axis of the conductive assistant particles,

$$Π \times {( b / 2 )}^{2} = x \times b ,$$

that is,

$$b = ( 4 / Π ) \times x \approx 1.27 x . \qquad ( 6 )$$

Here, the cross-sectional area s₁ of the sheet can be obtained from s₁=π×x×a based on the long axis length x and the short axis length a (μm) of the sheet in the cross section of the sheet. Where the aspect ratio of the conductive assistant particles in the cross section is represented by A (=x/a), the long axis length x is represented by the following equation:

$$\begin{matrix}x = {s}_{1} / ( Π \times a ) \\ = {s}_{1} / ( Π \times x / A ) \\ = {s}_{1} \times A / ( Π \times x ) \\ = {( {s}_{1} \times A / Π )}^{0.5} .\end{matrix}$$

Accordingly, from the equation in which the number-based average cross-sectional area s of the conductive assistant particles determined from the cross section is substituted for s₁ in the equation given above, and the equation (6),

$$b = 1.27 \times {( A \times s / Π )}^{0.5} .$$

Also, it is desirable that the shape of the conductive assistant particles observed in a cross section of the molded body of the electrode mixture is a shape whose long axis is longer than the short axis to some extent and that can easily come into contact with adjacent conductive assistant particles. Specifically, the aspect ratio A of the conductive assistant particles determined by observing the cross section is 1.5 or more, and preferably 2 or more. Also, it is preferable that the aspect ratio A of the conductive assistant particles determined by observing the cross section is, for example, within a range in which the circularity C of the conductive assistant particles, which will be described later, satisfies a later-described value. As a specific value of the aspect ratio A, the aspect ratio A is preferably 50 or less, and more preferably 10 or less.

Conductive assistant particles with an extremely distorted shape act as obstacles in an ion conductive path formed as a result of solid electrolyte particles coming into contact with each other, which may increase the degree of curvature of the ion conductive path and also increase the electrode resistance. Accordingly, the circularity C(=4π/L_{c}²) of the conductive assistant particles is preferably 0.3 or more, where the circumferential length in a cross section of the conductive assistant particles observed in a cross section of the molded body of the electrode mixture is represented by L_{c}.

The circularity C of the conductive assistant particles is less than 1 (for example, 0.99 or less), but is preferably in a range in which the aspect ratio A of the conductive assistant particles satisfies the above-described value.

The number-based average particle size D of the conductive assistant particles in the cross section is preferably 0.01 μm or more, and more preferably 0.05 μm or more, and preferably 0.23 μm or less, and more preferably 0.20 μm or less. Also, the average inter-centroid distance l of the conductive assistant particles in the cross section is preferably 0.01 μm or more, and more preferably 0.05 μm or more, and preferably 0.23 μm or less, and more preferably 0.20 μm or less.

Furthermore, the number-based average cross-sectional area s of the conductive assistant particles in the cross section is preferably 0.005 μm² or more, and more preferably 0.01 μm² or more, and preferably 100 μm² or less, and more preferably 10 μm² or less. Also, the total cross-sectional area S of the conductive assistant particles in the cross section is preferably 12.5 μm² or more, and more preferably 25 μm² or more, and preferably 250000 μm² or less, and more preferably 25000 μm² or less.

The observation of a cross section of the molded body of the electrode mixture can be performed using scanning electron microscope (SEM) images (at a magnification of 5000 times) at a plurality of arbitrarily selected points in a cross section of a molded body of the electrode mixture through focused ion beam (FIB) processing, and, from these images, the values of D, s, S, A, C, and l relating to the conductive assistant particles are determined. The number of conductive assistant particles observed in the observed field of view in the cross section is adjusted to 800 or more. The conductive assistant (specific examples thereof will be described later) that may be contained in the molded body of the electrode mixture is present in the form of primary particles or aggregate particles (secondary particles) in the molded body of the electrode mixture. However, in the observation of the cross section, each of these primary particles and aggregate particles is regarded as one particle. The conductive assistant particles in the SEM image can be confirmed through any of the following methods: energy dispersive X-ray spectroscopy (EDS) mapping analysis, electron probe micro analyzer (EPMA) analysis, and time-of-flight secondary ion mass (TOF-SIMS) mapping analysis.

Image analysis software can be used to sample the conductive assistant particles in the SEM image. Specifically, “Image J” is used to analyze a histogram of contrast of the image, a contrast region to which particles attributed to the conductive assistant belong is selected through EDS mapping analysis or the like as described above, and then the image is binarized. The binarized image is subjected to a single instance of each of erosion processing, dilation processing, Fill Halls processing, and erosion processing. By analyzing particles with an area of 0.005 μm² or more using the “Analyze Particles” option, 2500 or more particles can be sampled (at this time, particles in contact with the edge of the image are excluded).

For D, s (S), A, and C, values obtained by performing the “Analyze Particles” option together with elliptic approximation on an image obtained by binarizing each particle obtained through image analysis using Image J are used.

For the average inter-centroid distance L between conductive assistant particles, it can be determined by analyzing a data list of particle number and orthogonal coordinates of the centroid (geometric center) of each particle obtained by implementing the “Analyze Particles” option on an image obtained by binarizing each particle obtained through image analysis using Image J. The data list and a scikit-learn package are imported into Python, an euclidean distance of three particles (k=3) closest to each particle is calculated using a k-nearest neighbor method (k-nearest neighbor algorithm), and the obtained euclidean distance is output in the form of the data list. At this time, an overlap between adjacent particles is allowed. Based on the data list, the arithmetic average inter-particle distance L is determined. In the case where the particles are monodispersed particles and packed in a state close to the most closely packed state, the number of first neighboring particles is equal to k=6. However, considering the fact that an actual electrode contains a solid electrolyte and an electrode active material, the arithmetic average inter-particle distance L is calculated based on k=3 in order to preferentially analyze the distance between neighboring particles. The essence of the present invention is not affected even if the value of k is 1 to 6.

The values of D, s, S, A, C, and l shown in the Example section given later are values determined based on the above-described method.

The electrode of the present invention can be used as at least one of a positive electrode and a negative electrode included in an all-solid-state battery that includes a solid electrolyte layer.

The electrode of the present invention includes a molded body formed from an electrode mixture that contains an electrode active material, a solid electrolyte, and conductive assistant particles. Examples include a molded body (a pellet or the like) formed by molding the electrode mixture, a layer (an electrode mixture layer) formed on a current collector using the molded body of the electrode mixture, and the like.

In the case where the electrode of the present invention is used as a positive electrode in an all-solid-state battery, as the electrode active material, an active material capable of absorbing and desorbing lithium ions that is the same as those used in conventionally known lithium ion secondary batteries can be used. Specifically, it is possible to use one or more of various types of positive electrode active materials used in conventionally known non-aqueous electrolyte secondary batteries such as: a spinel-type lithium manganese composite oxide represented by LiMᵣMn₂₋ᵣO₄, where M represents at least one element selected from the group consisting of Li, Na, K, B, Mg, Ca, Sr, Ba, Ti, V Cr, Zr, Fe, Co, Ni, Cu, Zn, Al, Sn, Sb, In, Nb, Ta, Mo, W, Y, Ru, and Rh, and r satisfies 0≤r≤1; a layered compound represented by LiᵣMn_{(1·s·r)}Ni₈MₜO₍₂₋ᵤ₎Fᵥ, where M represents at least one element selected from the group consisting of Co, Mg, Al, B, Ti, Y Cr, Fe, Cu, Zn, Zr, Mo, Sn, Ca, Sr, and W, and r, s, t, u, and v satisfy 0.8≤r≤1.2, 0<s<0.5, 0<t≤0.5, u+v<1, −0.1≤u≤0.2, and 0≤v≤0.1; a lithium cobalt composite oxide represented by LiCo₁₋ᵣMᵣO₂, where M represents at least one element selected from the group consisting of Al, Mg, Ti, V Cr, Zr, Fe, Ni, Cu, Zn, Ga, Ge, Nb, Mo, Sn, Sb, and Ba, and r satisfies 0≤r≤0.5; a lithium nickel composite oxide represented by LiNi₁₋ᵣMᵣO₂, where M represents at least one element selected from the group consisting of Al, Mg, Ti, Zr, Fe, Co, Cu, Zn, Ga, Ge, Nb, Mo, Sn, Sb, and Ba, and r satisfies 0≤r≤0.5; an olivine-type composite oxide represented by Li₁₊ₛM₁₋ᵣNᵣPO₄Fₛ, where M represents at least one element selected from the group consisting of Fe, Mn, and Co, N represents at least one element selected from the group consisting ofAl, Mg, Ti, Zr, Ni, Cu, Zn, Ga, Ge, Nb, Mo, Sn, Sb, V and Ba, and r and s satisfy 0≤r≤0.5 and 0≤s≤1; and a pyrophosphate compound represented by Li₂M₁₋ᵣNᵣP₂O₇, where M represents at least one element selected from the group consisting of Fe, Mn, and Co, N represents at least one element selected from the group consisting of Al, Mg, Ti, Zr, Ni, Cu, Zn, Ga, Ge, Nb, Mo, Sn, Sb, V and Ba, and r satisfies 0≤r≤0.5.

In the case where the electrode of the present invention is used as the positive electrode, in the electrode active material (positive electrode active material), from the viewpoint of favorably suppressing a side reaction of the solid electrolyte, a reaction suppressing layer for suppressing a reaction with the solid electrolyte may be formed on the surface of the electrode active material.

The reaction suppressing layer may be made of a material that has lithium-ion conductivity and can suppress a reaction between the electrode active material (positive electrode active material) and the solid electrolyte. As a material that can constitute the reaction suppressing layer, an oxide that contain Li and at least one element selected from the group consisting of Nb, P, B, Si, Ge, Ti, Zr, Ta, and W can be used. More specific examples include an Nb-containing oxide such as LiNbO₃, as well as Li₃PO₄, Li₃BO₃, Li₄SiO₄, Li₄GeO₄, LiTiO₃, LiZrO₃, Li₂WO₄, and the like. The reaction suppressing layer may contain only one of these oxides, two or more of these oxides, or a composite compound formed by two or more of these oxides. Among these oxides, it is preferable to use an Nb-containing oxide, and more preferably LiNbO₃.

The reaction suppressing layer is preferably present on the surface of the electrode active material in an amount of 0.1 to 2.0 parts by mass relative to 100 parts by mass of the electrode active material. When the amount of the reaction suppressing layer is within this range, it is possible to favorably suppress a reaction between the electrode active material and the solid electrolyte.

The reaction suppressing layer can be formed on the surface of the electrode active material using a method such as a sol-gel method, a mechano-fusion method, a CVD method, a PVD method, an ALD method, or the like.

In the case where the electrode of the present invention is used as the negative electrode, as the negative electrode active material, for example, a carbon material such as graphite; a simple substance, a compound (an oxide or the like), or an alloy that contains an element such as Si, Sn, Ge, Bi, Sb, or In; a compound capable of charging and discharging at a low voltage close to that of a lithium metal such as a lithium-containing nitride or a lithium-containing oxide (a lithium titanium oxide such as Li₄Ti₅O₁₂), a niobium composite oxide such as TiNb₂O₇, a tungsten oxide, a molybdenum oxide, a vanadium oxide, or the like; or the like can be used. It is also possible to use a lithium metal or a lithium alloy (a lithium-aluminum alloy, a lithium-indium alloy, or the like) as the negative electrode active material.

Also, as the electrode active material, it is also possible to use a monoclinic niobium composite oxide represented by the following general formula (1).

MₓAl_{1·5x}Nb_{11+0.5x}O_{29·δ} (1)

In the general formula (1), M represents at least one element selected from Zn and Cu, and x and δ satisfy 0≤x≤0.4 and 0≤δ≤3.

That is, the niobium composite oxide that satisfies the general formula (1) may not contain the element M, or may contain at least one of Zn and Cu as the element M. In the case where the niobium composite oxide represented by the general formula (1) contains the element M, the amount x of the element M is preferably 0.05 or more because the effect of enhancing the output characteristics of the electrode (as well as the output characteristics of an all-solid-state battery that includes the electrode) is further improved. However, when the amount of the element M is too large in the niobium composite oxide represented by the general formula (1), the stability of the crystal structure may decrease to lower the charge/discharge cycle characteristics of the all-solid-state battery that includes the electrode. Accordingly, from the viewpoint of obtaining favorable charge/discharge cycle characteristics of the all-solid-state battery that includes the electrode, the amount x of the element M in the niobium composite oxide represented by the general formula (1) is preferably 0.4 or less, and more preferably 0.35 or less.

In the niobium composite oxide represented by the general formula (1), δ relating to the amount of oxygen is determined according to the valences of the elements M and Nb such that the amounts (valences) of the elements M, Nb, and Al that form cations match the amount (valence) of oxygen that forms anions. Specifically, the value of 6 is 0 or more and 3 or less.

In the niobium composite oxide represented by the general formula (1), as a result of pentavalent Nb and tetravalent Nb being present in a mixed manner, an oxygen deficiency may occur, or in other words, δ may take a value greater than 0 in the general formula (1). However, for example, when Cu is contained as the element M, although the reason is not clearly known, it is known that the effect of enhancing the output characteristics of the all-solid-state battery is further improved.

Also, as the niobium composite oxide used as the electrode active material of the electrode, it is also possible to use a niobium titanium composite oxide such as TiNb₂O₇ or Ti₂Nb₁₀O₂₉.

Due to charge of an all-solid-state battery in which the niobium composite oxide is used as the negative electrode active material, or pre-doping of Li ions before the niobium composite oxide is used in the all-solid-state battery, the niobium composite oxide is intercalated with Li ions, and thus contains Li. For example, in the case of the niobium composite oxide represented by the general formula (1), as a result of the niobium composite oxide being intercalated with Li ions, the niobium composite oxide satisfies, for example, the following general formula (2).

Li_{y}MₓAl_{1·1.5x}Nb_{11+0.5x}O_{29·δ} (2)

In the general formula (2), the element M, the amount x of the element M, and δ relating to the amount of oxygen are the same as those in the general formula (1), and y satisfies y≤22.

The niobium composite oxide used as the electrode active material may contain a representative element such as Na, K, Mg, Ca, C, S, P, or Si, or/and a transition element such as Ti, Zr, Fe, Cr, Ni, Mn, Ta, Y, Cu, or Zn, or may have a composition that contains Nb and at least one element selected from the above-listed elements, without containing Al. Also, the niobium composite oxide used as the electrode active material may contain moisture.

The niobium composite oxide represented by the general formula (1) and the niobium composite oxide represented by the general formula (2) can be used as the positive electrode active material or the negative electrode active material according to the type of active material used in a counter electrode for the electrode that contains the niobium composite oxide. Accordingly, in the case where the electrode of the present invention is used as the positive electrode, the niobium composite oxide represented by the general formula (1) and the niobium composite oxide represented by the general formula (2) can also be used as the positive electrode active material. Also, in the case where the electrode of the present invention is used as the negative electrode, the niobium composite oxide represented by the general formula (1) and the niobium composite oxide represented by the general formula (2) can also be used as the negative electrode active material. Also, the lithium titanium oxide mentioned as an example of the negative electrode active material can also function as a positive electrode active material depending on the type of active material contained in the counter electrode, and thus the lithium titanium oxide mentioned above can also be used as the positive electrode active material in the case where the electrode of the present invention is used as the positive electrode.

### (Method for Producing Niobium Composite Oxide)

There is no particular limitation on the method for producing a niobium composite oxide described above. For example, a niobium composite oxide can be synthesized and produced based on a solid-phase reaction method in which various types of metal oxides of Nb, Al, Cu, and Zn are mixed and fired, or a reaction method in which a metal compound mixture prepared by co-precipitating a chloride or a nitrate of each metal and an alkoxide in a liquid phase is used as a precursor.

In the solid-phase reaction method, from the viewpoint of enhancing interdiffusion of various types of metal ions, the firing is performed at a temperature of preferably 800° C. or more, and more preferably 900° C. to 1100° C. There is no particular limitation on the firing time, but the firing can be performed for 1 to 1000 hours. When the firing temperature is greater than 1100° C., the following problem may arise: oxygen is gradually released from a sample to generate a crystal phase other than a monoclinic crystal phase, or the composition no longer satisfies, for example, the general formula (1) and the general formula (2). For this reason, the time during which the firing temperature is maintained at 1100° C. or more is more preferably within 10 hours. There is no particular limitation on the cooling rate at which the sample is cooled during firing as long as a monoclinic crystal phase can be obtained. However, in order to obtain a stable monoclinic crystal phase in the above-described temperature range, the cooling rate is preferably 15° C./min to 60° C./min (including natural cooling). The sample may be quenched at a cooling rate of 1° C./see to 1000° C./sec.

### (Method for Determining Composition of Niobium Composite Oxide)

The composition of the niobium composite oxide can be analyzed based on, for example, inductively coupled plasma atomic emission spectroscopy (ICP-AES). In the case where it is difficult to perform quantification based on ICP-AES due to the reason where the niobium composite oxide is sintered with an oxide-based solid electrolyte, and it is therefore difficult to separate each component, or the like, it is also possible to determine the composition based on a combined method of various types of elemental analysis methods such as a combined method of a scanning electron microscope (SEM) or a transmission electron microscope (TEM) with an energy dispersive X-ray spectrometer (EDS) or a wavelength dispersive X-ray spectrometer (WDS).

### (Method for Confirming Oxygen Deficiency in Niobium Composite Oxide)

Whether an oxygen deficiency has occurred in the niobium composite oxide can be confirmed by determining, based on X-ray photoelectron spectroscopy analysis (XPS), whether a peak attributed to pentavalent Nb and a peak attributed to tetravalent Nb are present in a mixed manner in the composite oxide (confirmation was performed based on this method in the Example section given later). By setting the CIs peak position of contaminated hydrocarbon on the sample surface to 284.6 eV charge correction of binding energy of spectrum is performed to obtain an XPS spectrum in a binding energy range of 202 eV to 214 eV. Then, the background shape is estimated based on the iterative Shirley method to remove background from the spectrum. The obtained spectrum is subjected to peak fitting using the Pseudo-Voigt function. Then, the area of a peak attributed to Nb⁵⁺ of Nb3d3/2 (obtained at a position at which the binding energy is 209.8 eV to 210.2 eV) and the area of a peak attributed to Nb⁴⁺ (the peak is obtained at a position at which the binding energy is smaller than the peak position attributed to 3d3/2 of Nb⁵⁺ by 0.5 eV to 2 eV) are determined to calculate the average valence of Nb. Likewise, the area of a peak attributed to Nb⁵⁺ of Nb3d5/2 (obtained at a position at which the binding energy is 206.6 eV to 207.1 eV) and the area of a peak attributed to Nb⁴⁺ (the peak is obtained at a position at which the binding energy is smaller than the peak position attributed to 3d5/2 of Nb⁵⁺ by 0.5 eV to 2 eV) are determined to calculate the average valence of Nb. The average valence of Nb calculated from Nb3d3/2 and the average valence of Nb calculated from Nb3d5/2 are averaged to determine the average valence of Nb contained in the active material.

The average valence of Cu can also be determined in the same manner as the average valence of Nb. An XPS spectrum in a binding energy range of 925 eV to 950 eV is obtained, and the area of a peak attributed to Cu²⁺ of Cu2p3/2 (obtained at a position at which the binding energy is 932.7 eV to 934.6 eV) and the area of a peak attributed to Cu⁺ (the peak is obtained at a position at which the binding energy is smaller than the peak position attributed to 2p3/2 of Cu²⁺ by 0.5 eV to 2 eV) are determined to determine the average valence of Cu.

Next, the amount of each of various types of metal elements is quantified based on inductively coupled plasma atomic emission spectrometry (ICP-AES). 5 mg of a sample is placed in a platinum crucible, and 5 ml of hydrofluoric acid, 10 ml of 50 mass % sulfuric acid are added thereto to perform thermal decomposition processing. In this way, a mixture of concentrated sulfuric acid and a fluoride of each of various types of metal elements is obtained (at this time, the hydrofluoric acid turns into white fumes and is removed). 2 ml of 30 mass % hydrogen peroxide solution is added to the obtained mixture, and then the sample is diluted with pure water to 100 ml using a measuring flask. The obtained sample solution and a standard solution with a known concentration of each of various types of metal elements are alternately subjected to measurement three times. Then, the average values thereof are calculated, respectively, and the amount of metal element in the sample is determined from the ratio of the signal intensity of the sample solution relative to that of the standard solution.

Based on the average valences of Nb element and Cu element determined through XPS analysis (it is assumed that all Al exists in the form of Al³⁺) and the amount of each of various types of metal elements determined through ICP-AES, the total charge amount of cations contained in the sample is calculated, and the amount of oxygen anions (O^{2·}) is calculated to be electrically neutral with respect to the total charge amount of cations obtained. Then, the difference with respect to the amount of oxygen anions when it is assumed that the niobium composite oxide does not have an oxygen deficiency is defined as oxygen deficiency amount 6. Specifically, in the case of the niobium composite oxide represented by the general formula (1), the oxygen deficiency amount 6 is the difference between the amount of oxygen when it is assumed that Al, Cu, and Nb contained in the sample are constituted by Al³⁺, Cu²⁺, and Nb⁵⁺ and the amount of oxygen obtained based on the above-described method.

The amount of oxygen in the sample may be directly quantified based on a method in which the sample is placed in a graphite crucible, subjected to resistance heating in a helium stream to detect generated carbon dioxide using an infrared detector.

### (Method for Confirming Monoclinic Structure of Niobium Composite Oxide)

The crystal structure of the niobium composite oxide can be determined by measuring a powder X-ray diffraction (powder XRD) pattern using RINT 2500 VPC (X rays used: CuKα rays) available from Rigaku Corporation, and checking it against the Powder Diffraction File (PDF) database or analyzing it based on the Rietveld method. In the case of comparing crystal lattice sizes between different samples, an Si powder (available from Rigaku Corporation, a₀=5.4308 Å at 298.1 K) is mixed as an internal reference when preparing a sample for powder XRD measurement, and the spectrum is corrected such that a peak attributed to the (111) plane of Si on the X-ray diffraction pattern is 2θ=28.442 degrees. The lattice constant (d₀₁₀) of a unit lattice in the b axis direction can be calculated by setting the wavelength of X rays to 1.5418 Å, and doubling the lattice spacing determined from a peak attributed to the diffraction in the (020) plane. In the case where the niobium composite oxide is contained in the electrode (negative electrode) as the negative electrode active material, a powder XRD pattern of the electrode can be obtained by connecting a 1 kΩ resistor to the battery, subjecting the battery to constant resistance discharge for 100 hours, thereafter, taking out the negative electrode from the battery flattening the electrode such that a surface opposing a bonding surface bonding to a current collector of the electrode is parallel to the current collector, and then fixing the electrode to the powder XRD sample stage. In the case where the niobium composite oxide is contained in the electrode (positive electrode) as the positive electrode active material, a powder XRD pattern of the electrode can be obtained by subjecting the battery to constant current charge at 10 μA to an upper limit voltage of 3 V and then holding the battery in a constant voltage state of 3 V for 100 hours, thereafter, taking out the positive electrode from the battery, and then, as in the case of the negative electrode, flattening the electrode such that a surface opposing a bonding surface bonding to a current collector of the electrode is parallel to the current collector, and then fixing the electrode to the powder XRD sample stage.

In the case where the niobium composite oxide is sintered with a crystalline sulfide-based solid electrolyte or an oxide-based solid electrolyte, the monoclinic structure of the niobium composite oxide can be confirmed by extracting a sample piece from a molded body of a sample containing the niobium composite oxide through focused ion beam (FIB) processing, placing the sample piece on a TEM sample stage to perform thin film processing to obtain a thin piece with a thickness of 100 nm or less, obtaining a selected area electron diffraction (SAED) pattern of the thin piece using a TEM, and analyzing the obtained pattern.

In the case where the electrode of the present invention is used as the positive electrode, the amount of the electrode active material (positive electrode active material) contained in the electrode mixture (positive electrode mixture) is preferably to 95 mass %.

On the other hand, in the case where the electrode of the present invention is used as the negative electrode, the amount of the electrode active material (negative electrode active material) contained in the electrode mixture (negative electrode mixture) is preferably 10 to 99 mass %.

The electrode mixture contains conductive assistant particles. Specific examples of the conductive assistant particles include particles of carbon materials such as graphite (natural graphite, artificial graphite), graphene, carbon black, carbon nanofibers, and carbon nanotubes. The amount of the conductive assistant particles contained in the electrode mixture is preferably 1 to 10 mass %. By adjusting the amount of the conductive assistant particles contained in the electrode mixture, the value of S/Sₜₒₜ can be adjusted.

The electrode mixture contains a solid electrolyte. There is no particular limitation on the solid electrolyte as long as the solid electrolyte has Li ion conductivity. For example, a sulfide-based solid electrolyte, a hydride-based solid electrolyte, a halide-based solid electrolyte, an oxide-based solid electrolyte, or the like can be used.

Examples of the sulfide-based solid electrolyte include particles of Li₂S—P₂S₅-based glass, Li₂S-SiS₂-based glass, Li₂S—P₂S₅-GeS₂-based glass, Li₂S—B₂S₃-based glass, and the like. It is also possible to use thio-LISICON-type sulfide-based solid electrolyte (Li_{12·12a-b+c+6d·e}M¹_{3+a·b·c·d} M²_{b}M³_{c}M⁴_{d}M⁵_{12·e}Xₑ (where M¹ represents Si, Ge, or Sn, M² represents P or V M³ represents Al, Ga, Y or Sb, M⁴ represents Zn, Ca, or Ba, M⁵ represents S, or S and O, X represents F, Cl, Br, or I, and a, b, c, d, and e satisfy 0≤a<3, 0≤b+c+d≤3, and 0≤e≤3), such as Li₁₀GeP₂S₁₂ and Li_{9.54}Si_{1.74}P_{1.44}S_{11.7}Cl_{0.3}), and argyrodite-type sulfide-based solid electrolyte (Li_{7f+g}PS_{6·X}Cl_{x+y} (where f and g satisfy 0.05≤f≤0.9, and −3.0f+1.8≤g≤−3.0f+5.7), such as Li₆PS₅Cl), and Li_{7·h}PS₆₋ₕClᵢBrⱼ (where h, i, and j satisfy h=i+j, 0<h≤1.8, and 0.1≤i/j≤10.0), which have attracted attention in recent years due to their high Li ion conductivity.

Examples of the hydride-based solid electrolyte include LiBH₄, and a solid solution of LiBH₄ and any of the following alkali metal compounds (for example, a solid solution of LiBH₄ and an alkali metal compound at a mole ratio of 1:1 to 20:1). As the alkali metal compound used in the above-mentioned solid solution, at least one selected from the group consisting of lithium halides (for example, LiI, LiBr, LiF, LiCl, and the like), rubidium halides (for example, RbI, RbBr, RbF, RbCl, and the like), cesium halides (for example, CsI, CsBr, CsF, CsCl, and the like), lithium amides, rubidium amides, and cesium amides can be used.

Examples of the halide-based solid electrolyte include monoclinic LiAlCl₄, defect spinel or layered LiInBr₄, and monoclinic L_{6·3m} YₘX₆ (where m satisfies 0<m<2, and X═Cl or Br). It is also possible to use known solid electrolytes disclosed in WO 2020/070958 and WO 2020/070955.

Examples of the oxide-based solid electrolytes include Li₂O·Al₂O₃·SiO₂·P₂O₅ —TiO₂-based glass ceramics, Li₂O—Al₂O₃—SiO₂—P₂O₅—GeO₂-based glass ceramics, garnet-type Li₇La₃Zr₂O₁₂, NASICON-type Li_{1+O}Al_{1+O}Ti_{2·O}(PO₄)₃ and Li₁₊ₚAl₁₊ₚGe_{2·p}(PO₄)₃, and perovskite-type Li_{3q}La_{2/3·q}TiO₃.

Among these solid electrolytes, it is preferable to use a sulfide-based solid electrolyte because of its high Li ion conductivity. It is more preferable to use a sulfide-based solid electrolyte that contains Li and P. In particular, it is even more preferable to use an argyrodite-type sulfide-based solid electrolyte that has high Li ion conductivity and high chemical stability.

From the viewpoint of reducing grain boundary resistance, the average particle size of the solid electrolyte is preferably 0.1 μm or more, and more preferably 0.2 μm or more. On the other hand, from the viewpoint of forming a sufficient contact interface between the positive electrode active material and the solid electrolyte, the average particle size of the solid electrolyte is preferably 10 μm or less, and more preferably 5 μm or less.

The term “the average particle size of the solid electrolyte” used in the specification of the present application refers to a 50% diameter value (D₅₀) in a volume-based integrated fraction when an integral volume is obtained in order from the smallest particle size using a particles size distribution measurement apparatus (Microtrac HRA 9320 available from Nikkiso Co., Ltd., or the like).

In the case where the electrode of the present invention is used as the positive electrode, the amount of the solid electrolyte contained in the electrode mixture (positive electrode mixture) is preferably 4 to 80 mass %. In the case where the electrode of the present invention is used as the negative electrode, the amount of the solid electrolyte in the electrode mixture (negative electrode mixture) is preferably 4 to 85 mass %.

The electrode mixture may contain a binder. Specific examples of the binder include a fluorine resin such as polyvinylidene fluoride (PVDF), and the like. The electrode mixture does not necessarily need to contain a binder when, for example, favorable moldability can be ensured during forming the molded body of the electrode mixture even without a binder such as when the electrode material contains a sulfide-based solid electrolyte.

In the case where a binder is required in the electrode mixture, the amount of the binder is preferably 6 mass % or less, and preferably 0.5 mass % or more. On the other hand, in the case where moldability can be obtained even without a binder because the electrode mixture contains a sulfide-based solid electrolyte, the amount of the binder is preferably 0.5 mass % or less, more preferably 0.3 mass % or less, and even more preferably 0 mass % (or in other words, the electrode mixture contains no binder).

In the case where the electrode is used as the positive electrode and includes a current collector, as the current collector, a foil, a punched metal, a mesh, an expanded metal, a foamed metal made of metal such as aluminum, nickel, or stainless steel; a carbon sheet; or the like can be used. Also, in the case where the electrode is used as the negative electrode and includes a current collector, as the current collector, a foil, a punched metal, a mesh, an expanded metal, a foamed metal made of copper or nickel; a carbon sheet; or the like can be used.

The molded body of the electrode mixture can be formed by, for example, compressing an electrode mixture prepared by mixing an electrode active material, a solid electrolyte, conductive assistant particles, and the like through compression molding or the like.

In the case where the electrode includes a current collector, the electrode can be produced by attaching the molded body of the electrode mixture obtained based on the above-described method to a current collector through press-bonding or the like.

Also, the molded body of the electrode mixture may also be formed by mixing the above-described electrode mixture with a solvent to prepare an electrode mixture-containing composition, applying the electrode mixture-containing composition onto a substrate such as a current collector or a solid electrolyte layer to be placed to oppose the electrode, and then drying and pressing the substrate.

As the solvent used in the electrode mixture-containing composition, it is preferable to select a solvent that is less likely to deteriorate the solid electrolyte. In particular, a sulfide-based solid electrolyte and a hydride-based solid electrolyte cause a chemical reaction with a minute amount of water, and it is therefore preferable to use a non-polar aprotic solvent as typified by a hydrocarbon solvent such as hexane, heptane, octane, nonane, decane, decaline, toluene, xylene, mestyrene, or tetralin. In particular, it is more preferable to use a super dehydrated solvent with a water content of 0.001 mass % (10 ppm) or less. It is also possible to use a fluorine-based solvent such as VERTREL (registered trademark) available from Du Pont-Mitsui Fluorochemicals Co., Ltd., ZEORORA (registered trademark) available from Zeon Corporation Japan, and NOVEC (registered trademark) available from Sumitomo 3M Ltd, and a non-aqueous organic solvent such as dichloromethane, diethyl ether, or anisole.

The values of D, A, and C relating to the conductive assistant particles can be adjusted by selecting the shape of conductive assistant particles used, adjusting a mixing condition when preparing the electrode mixture or the electrode mixture-containing composition, or the like.

The thickness of the molded body of the electrode mixture (in the case where the electrode includes a current collector, it refers to the thickness of the molded body of the electrode mixture per side of the current collector, and the same applies hereinafter) is usually 100 μm or more, and from the viewpoint of achieving a high capacity of all-solid-state battery, preferably 200 μm or more. Generally speaking, the output characteristics of an all-solid-state battery can be easily improved by reducing the thickness of the positive electrode or the negative electrode to be thin. However, according to the present invention, even when the molded body of the electrode mixture is as thick as 200 μm or more, the output characteristics of the all-solid-state battery can be enhanced. In particular, in the case where the electrode of the present invention is used as the positive electrode, there is little influence of an increase in the resistance of the positive electrode caused by decomposition of the solid electrode that occurs in the positive electrode, and thus even when the molded body of the electrode mixture (the molded body of the positive electrode mixture) is as thick as 200 μm or more, favorable output characteristics can be ensured. Accordingly, in the present invention, this advantageous effect becomes more prominent when the thickness of the molded body of the electrode mixture is, for example, 200 μm or more. Also, the thickness of the molded body of the electrode mixture is usually 3000 μm or less.

In the case where the electrode is produced by forming an electrode mixture layer on a current collector using an electrode mixture-containing composition that contains a solvent, the thickness of the electrode mixture layer is preferably 10 to 1000 μm.

### <All-Solid-State Battery>

An all-solid-state battery according to the present invention includes a positive electrode, a negative electrode, and a solid electrolyte layer interposed between the positive electrode and the negative electrode, and at least one of the positive electrode and the negative electrode is the all-solid-state battery electrode of the present invention. As constituent elements other than the electrode, various types of constituent elements used in conventionally known all-solid-state batteries can be used.

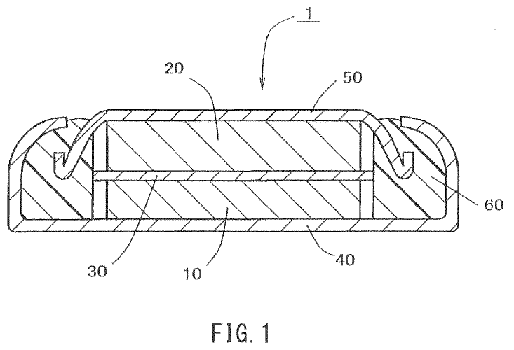

Across-sectional view schematically showing an example of an all-solid-state battery according to the present invention is shown in FIG. 1. An all-solid-state battery 1 shown in FIG. 1 includes a positive electrode 10, a negative electrode 20, and a solid electrolyte layer 30 interposed between the positive electrode 10 and the negative electrode 20 that are enclosed in an exterior body formed of an exterior can 40, a sealing can 50, and a resin gasket 60 provided between the exterior can 40 and the sealing can 50.

The sealing can 50 is fitted to an opening of the exterior can 40 via the gasket 60, and an opening end of the exterior can 40 is inwardly fastened, thereby causing the gasket 60 to abut against the sealing can 50. In this way, the opening of the exterior can 40 is sealed, and thus the inside of the battery has a hermetically sealed structure.

As the exterior can and the sealing can, stainless steel cans or the like can be used. Also, as the material of the gasket, polypropylene, nylon, or the like can be used. Other than these, in the case where heat resistance is required depending on the application of the battery, it is also possible to use a heat resistant resin that has a melting point of greater than 240° C. such as: a fluorine resin such as a tetrafluoroethylene-perfluoroalkoxy ethylene copolymer (PFA); polyphenylene ether (PPE); polysulfone (PSF); polyarylate (PAR); polyether sulfone (PES); polyphenylene sulfide (PPS); or polyetheretherketone (PEEK). In the case where the battery is used in applications where heat resistance is required, a glass hermetic seal can also be used for sealing.

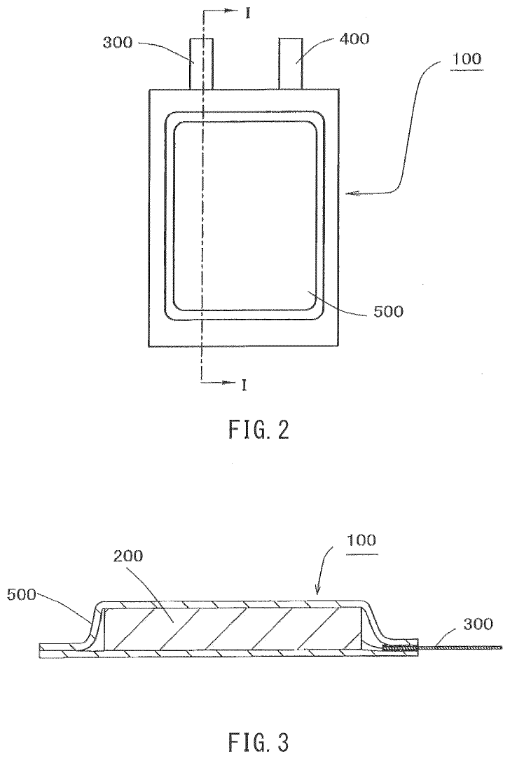

Also, FIGS. 2 and 3 schematically show another example of an all-solid-state battery according to the present invention. FIG. 2 is a plan view of the all-solid-state battery, and FIG. 3 is a cross-sectional view taken along the line I-I shown in FIG. 2.

An all-solid-state battery 100 shown in FIGS. 2 and 3 houses an electrode body 200 in a laminate-film exterior body 500 formed of two metal laminate films. The laminate-film exterior body 500 is sealed at its outer circumferential portion by heat fusing the upper and lower metal laminate films.

The electrode body 200 is formed by stacking a positive electrode, a negative electrode, and a solid electrolyte layer interposed between the positive electrode and the negative electrode.

In FIG. 3, to avoid making the diagram complicated, the layers that constitute the laminate-film exterior body 500 and the constituent elements (the positive electrode, the negative electrode, and the like) that constitute the electrode body 200 are not shown in a distinguished manner.

The positive electrode included in the electrode body 200 is connected to a positive electrode external terminal 300 in the battery 100. Also, although not shown in the diagram, the negative electrode included in the electrode body 200 is also connected to a negative electrode external terminal 400 in the battery 100. One end of the positive electrode external terminal 300 and one end of the negative electrode external terminal 400 are drawn out of the laminate-film exterior body 500 so as to be connected to external devices and the like.

### (Positive Electrode)

As the positive electrode of the all-solid-state battery, the electrode of the present invention can be used. However, in the case where the electrode of the present invention is used as the negative electrode, a positive electrode that is different from the electrode of the present invention can also be used. Examples of the positive electrode that is different from the electrode of the present invention include a positive electrode that has the same configuration as that of the electrode of the present invention, except that L and b do not satisfy the above-described relationship, a positive electrode that has the same configuration as that of the electrode of the present invention, except that A is less than 1.5, and the like.

### (Negative Electrode)

As the negative electrode of the all-solid-state battery, the electrode of the present invention can be used. However, in the case where the electrode of the present invention is used as the positive electrode, a negative electrode that is different from the electrode of the present invention can also be used. Examples of the negative electrode that is different from the electrode of the present invention include a negative electrode that has the same configuration as that of the electrode of the present invention, except that L and b do not satisfy the above-described relationship, a negative electrode that has the same configuration as that of the electrode of the present invention, except that A is less than 1.5, a negative electrode that includes a lithium sheet or a lithium alloy sheet, and the like.

In the case where the negative electrode is a negative electrode that is different from the electrode of the present invention, and includes a molded body of a negative electrode mixture, the amount of the solid electrolyte can be set to 0 to 85 mass %.

In the case of the negative electrode that includes a lithium sheet or a lithium alloy sheet, a negative electrode that includes only a lithium sheet or a lithium alloy sheet, or a negative electrode formed by attaching a lithium sheet or a lithium alloy sheet to a current collector can be used.

As an alloying element used in the lithium alloy, aluminum, lead, bismuth, indium, or gallium can be used, but it is preferable to use aluminum or indium. The proportion of the alloying element contained in the lithium alloy (in the case where the lithium alloy contains a plurality of types of alloying elements, the total proportion of the alloying elements) is preferably 50 atomic % or less (in this case, the remainder is lithium and inevitable impurities).

Also, in the case of the negative electrode that includes a lithium alloy sheet, using a stacked body prepared by stacking a alloying element-containing layer for forming a lithium alloy on the surface of a lithium layer (a lithium-containing layer) made of a lithium metal foil or the like through press-bonding, the stacked body may be brought into contact with a solid electrolyte in the battery to form a lithium alloy on the surface of the lithium layer, and used as the negative electrode. In the case of this negative electrode, a stacked body that includes an alloying element-containing layer on only one surface of the lithium layer may be used, or a stacked body that includes alloying element-containing layers on both surfaces of the lithium layer may be used. The stacked body can be formed by, for example, press-bonding a lithium metal foil and a foil made of an alloying element to each other.

Also, a current collector can also be used when a lithium alloy is formed in the battery and used as the negative electrode. For example, a stacked body that includes a lithium layer on one surface of a negative electrode current collector and an alloying element-containing layer on a surface of the lithium layer opposite to the negative electrode current collector may be used, or a stacked body that includes lithium layers on both surfaces of a negative electrode current collector and alloying element-containing layers each on the surface of the corresponding lithium layer that is opposite to the negative electrode current collector may be used. The negative electrode current collector and the lithium layer (lithium metal foil) may be stacked on each other through press-bonding or the like.

As the alloying element-containing layer included in the stacked body used as the negative electrode, for example, a foil or the like made of any of the alloying elements listed above can be used. The thickness of the alloying element-containing layer is preferably 1 μm or more, and more preferably 3 μm or more, and preferably 20 μm or less, and more preferably 12 μm or less.

As the lithium layer included in the stacked body used as the negative electrode, for example, a lithium metal foil or the like can be used. The lithium layer preferably has a thickness of 0.1 to 1.5 mm. Also, the sheet included in the negative electrode that includes a lithium sheet or a lithium alloy sheet preferably has a thickness of 0.1 to 1.5 mm.

Also, in the case where the negative electrode that includes a lithium sheet or a lithium alloy sheet includes a current collector, as the current collector, it is possible to use the same current collector as those listed above as examples of the current collector that can be used in the case where the electrode of the present invention is used as the negative electrode.

### (Solid Electrolyte Layer)

As the solid electrolyte contained in the solid electrolyte layer interposed between the positive electrode and the negative electrode, it is possible to use one or more of the various types of sulfide-based solid electrolytes, hydride-based solid electrolytes, halide-based solid electrolytes, and oxide-based solid electrolytes listed above as examples of the solid electrolyte that can be used in the electrode. However, in order to make the battery characteristics more excellent, the solid electrolyte layer desirably contains a sulfide-based solid electrolyte, and more desirably an argyrodite-type sulfide-based solid electrolyte. It is even more desirable that all of the positive electrode, the negative electrode, and the solid electrolyte layer contain a sulfide-based solid electrolyte, and it is yet even more desirable that all of them contain an argyrodite-type sulfide-based solid electrolyte.

The solid electrolyte layer may include a porous body such as a resin non-woven fabric as a support.

The solid electrolyte layer can be formed using any of the following methods: a method of compressing a solid electrolyte through compression molding or the like; a method of applying a solid electrolyte layer-forming composition prepared by dispersing a solid electrolyte in a solvent onto a substrate (including a porous body that serves as a support), the positive electrode, or the negative electrode, drying the composition, and performing compression molding such as pressing as needed; and the like.

As the solvent used in the solid electrolyte layer-forming composition, it is desirable to select a solvent that is less likely to deteriorate the solid electrolyte, and it is preferable to use any of the same solvents as those listed above as various examples of the solvent for the electrode mixture-containing composition.

The thickness of the solid electrolyte layer is preferably 10 to 500 μm.

### (Electrode Body)

The positive electrode and the negative electrode can be used in the battery in the form of a stacked electrode body obtained by stacking the positive electrode and the negative electrode with a solid electrolyte layer interposed therebetween, or a wound electrode body obtained by spirally winding the stacked electrode body.

From the viewpoint of increasing the mechanical strength of the electrode body, it is preferable to form the electrode body by stacking the positive electrode, the negative electrode, and the solid electrolyte layer and then compression molding them.

### (Battery Configuration)

As the configuration of the all-solid-state battery, other than the configuration shown in FIG. 1 that includes an exterior body composed of an exterior can, a sealing can, and a gasket, or in other words, the configuration generally called a coin type battery or a button type battery, and the configuration shown in FIGS. 2 and 3 that includes an exterior body formed using a resin film or a metal-resin laminate film, the all-solid-state battery may have a configuration that includes an exterior body that includes a bottomed cylindrical (circular-cylindrical or prismatic) exterior can made of a metal and a sealing structure that seals an opening of the exterior can.

### EXAMPLES

Hereinafter, the present invention will be described in detail based on examples. However, the examples given below do not limit the scope of the present invention.

### Example 1

### Production of Positive Electrode

A reaction suppressing layer-forming coating solution was prepared by mixing 0.86 g of lithium and 38.7 g of pentaethoxyniobium in 394 g of dehydrated ethanol. Next, the reaction suppressing layer-forming coating solution was applied onto 1000 g of a positive electrode active material (LiCoO₂) at a rate of 2 g per min using a coating apparatus with a rolling fluidized bed. The obtained powder was subjected to heat treatment at 350° C. to obtain a positive electrode material in which a reaction suppressing layer made of 2 parts by mass of LiNbO₃ relative to 100 parts by mass of the positive electrode active material was formed on the surface of the positive electrode material.

A positive electrode mixture was prepared by mixing the positive electrode material obtained above with vapor grown carbon fibers (as a conductive assistant) and Li₆PS₅Cl(as a sulfide-based solid electrolyte). The mixing ratio between the positive electrode material, the conductive assistant, and the sulfide-based solid electrolyte was 66:4:30 by mass. 117 mg of the positive electrode mixture was placed in a powder molding mold with a diameter of 7.5 mm, and molded at a pressure of 1000 kgf/cm² using a pressing machine. In this way, a positive electrode made of a circular-cylindrical positive electrode mixture molded body was produced.

### Formation of Solid Electrolyte Layer

A solid electrolyte layer was formed on the positive electrode mixture molded body by placing 17 mg of the same sulfide-based solid electrolyte as that used in the positive electrode on the positive electrode mixture molded body in the powder molding mold, and molding it at a pressure of 1000 kgf/cm² using a pressing machine.

### Formation of Negative Electrode and Production of Stacked Electrode Body

An active material was synthesized using various types of metal oxide powders (all obtained from Kojundo Chemical Lab. Co., Ltd.) as starting materials based on a solid-phase reaction method. Nb₂O (purity: >99.9%) with an average particle size of 1 μm, α-Al₂O₃(purity: >99.99%) with an average particle size of 1 μm, and CuO (purity: >99.99%) were weighed to 96.72 g, 2.34 g, and 1.04 g, respectively, and then mixed. The mixture of the starting materials was placed in a zirconia container with an internal volume of 500 ml together with 70 g of ethanol and 300 g of YSZ balls with a diameter of 5 mm, and mixed at 250 rpm for 3 hours using a planetary ball mill (Planetary Mill Pulverisette 5 (product name) available from Fritsch GmbH). Zirconia balls were separated from the mixed sample to obtain a slurry, and the slurry was dried to obtain a negative electrode active material precursor powder. The precursor powder was transferred to an alumina crucible and then fired by increasing the temperature to 1000° C. in an air atmosphere at a temperature increase rate of 16° C./min, and maintaining the temperature for 4 hours. After that, the precursor powder was naturally cooled to room temperature. The obtained powder was crushed for 5 minutes using a mortar, and sieved using a sieve with a mesh size of 150 μm to obtain a crude product of active material. 4 g of the crude product of active material was placed in a zirconia container with an internal volume of 12.5 ml together with 4 g of ethanol and 30 g of YSZ balls with a diameter of 5 mm, and crushed at 250 rpm for 3 hours using the above-described planetary ball mill. The obtained slurry was dried under reduced pressure at 60° C. overnight to obtain a negative electrode active material Cu_{0.2}Al_{0.74}Nb_{11.1}O_{27.9}.

A powder XRD pattern of the obtained negative electrode active material was measured, and it was confirmed that the negative electrode active material had a monoclinic crystal structure and belonged to the C2/m space group.

The negative electrode active material, the sulfide-based solid electrolyte (Li₆PS₅Cl) and graphene (conductive assistant particles) were mixed at a mass ratio of 69:25.5:5.5, and kneaded in an argon atmosphere for 1 hour using an automatic mortar (Mortar Grinder P-2 (product name) available from Fritsch GmbH) to prepare a negative electrode mixture. Next, 57 mg of the negative electrode mixture was placed on the solid electrolyte layer in the powder molding mold, and molded at a pressure of 10000 kgf/cm² using a pressing machine to form a negative electrode made of a negative electrode mixture molded body on the solid electrolyte layer. In this way, a stacked electrode body in which the positive electrode, the solid electrolyte layer, and the negative electrode were stacked was produced. For the conductive assistant particles contained in the obtained negative electrode (negative electrode mixture molded body), the following values were obtained: D: 0.15 μm, 1:0.62 μm, L: 0.41 μm, A: 2.7, s: 0.17 μm², b: 0.49 μm, S: 95.81 μm², S/Sₜₒₜ: 5.3%, and C: 0.36.

### <Assembly of All-Solid-State Secondary Battery>

A flexible graphite sheet PERMA-FOIL (product name) with a thickness of 0.1 mm and an apparent density of 1.1 g/cm³ available from Toyo Tanso Co., Ltd. was punched into two sheets of the same size as that of the stacked electrode body. One of the obtained two graphite sheets was placed on the inner bottom of a stainless steel sealing can in which a polypropylene annular gasket was fitted. Next, the stacked electrode body was placed on the graphite sheet, with the negative electrode facing the graphite sheet, and the other graphite sheet was placed on the stacked electrode body. Furthermore, the sealing can was covered with a stainless steel exterior can, and then sealed by inwardly crimping the opening end of the exterior can. In this way, a flat-shaped all-solid-state secondary battery with a diameter of about 9 mm in which one of the graphite sheets was placed between the inner bottom of the sealing can and the stacked electrode body, and the other one of the graphite sheets was placed between the inner bottom of the exterior can and the stacked electrode body was obtained.

### Example 2

A stacked electrode body was produced by forming a negative electrode in the same manner as in Example 1, except that the mixing time of the starting materials for negative electrode active material was changed to 6 hours. For the conductive assistant particles contained in the obtained negative electrode (negative electrode mixture molded body), the following values were obtained: D: 0.14 μm, 1:0.66 μm, L: 0.42 μm, A: 2.8, s: 0.15 μm², b: 0.46 μm, S: 64.65 μm², S/Sₜt: 4.1%, and C: 0.36. Then, an all-solid-state secondary battery was produced in the same manner as in Example 1, except that the stacked electrode body produced above was used.

### Comparative Example 1

A stacked electrode body was produced by forming a negative electrode in the same manner as in Example 1, except that the mixing time of the negative electrode mixture was changed to 5 minutes. For the conductive assistant particles contained in the obtained negative electrode (negative electrode mixture molded body), the following values were obtained: D: 0.25 μm, 1:0.8 μm, L: 0.58 μm, A: 1.4, s: 0.13 μm², b: 0.31 μm, S: 314.89 μm², S/Sₜₒₜ: 11%, and C: 0.41. Then, an all-solid-state secondary battery was produced in the same manner as in Example 1, except that the stacked electrode body produced above was used.

The all-solid-state secondary batteries produced in Examples 1 and 2 and Comparative Example 1 were subjected to the following evaluation tests.

### <Discharge Capacity Measurement>

Each of the all-solid-state secondary batteries produced in Examples 1 and 2 and Comparative Example 1 was subjected to constant current charge at a current value of 0.05 C to a voltage of 3.5 V then constant voltage charge to a current value of 0.005 C, and thereafter constant current discharge at a current value of 0.05 C to a voltage of 1.0 V. The discharge capacity at this time (initial capacity) was measured.

### <Output Characteristics Evaluation>

After the initial capacity measurement, each battery was subjected to constant current charge at a current value of 0.05 C to a voltage of 3.5 V constant voltage charge to a current value of 0.005 C, open end voltage measurement for 1 hour, and constant current discharge at a current value of 0.05 C to a voltage of 1.0 V to measure 0.05 C discharge capacity. Next, the battery was subjected to open end voltage measurement for 1 hour, and constant current discharge at a current value of 0.01 C to a voltage of 1.0 V. Then, the sum of the obtained discharge capacity and the 0.05 C discharge capacity was defined as 0.01 C discharge capacity.

Then, the output characteristics of the battery were evaluated by calculating the ratio of the 0.05 C discharge capacity relative to the 0.01 C discharge capacity being set to 100% (0.05 C/0.01 C discharge capacity retention rate).

The configuration of the conductive assistant particles contained in the negative electrode in each of the all-solid-state secondary batteries produced in Examples 1 and 2 and Comparative Example 1 is shown in Table 1, and the evaluation results are shown in Table 2. The evaluation results shown in Table 2 are indicated by relative values with the values of the all-solid-state secondary battery of Comparative Example 1 being set to 100.

TABLE 1

| | L | | b | | S/Sₜₒₜ |
|---|---|---|---|---|---|
| | (μm) | A | (μm) | C | (%) |
| Example 1 | 0.41 | 2.7 | 0.49 | 0.36 | 5.3 |
| Example 2 | 0.42 | 2.8 | 0.46 | 0.36 | 4.1 |
| Comparative | 0.58 | 1.4 | 0.31 | 0.41 | 11 |
| Example 1 | | | | | |

TABLE 2

| | Discharge capacity | Output characteristics |
|---|---|---|
| Example 1 | 124 | 203 |
| Example 2 | 128 | 205 |
| Comparative | 100 | 100 |
| Example 1 | | |

As shown in Tables 1 and 2, each of the all-solid-state secondary batteries of Examples 1 and 2 produced using the negative electrode that included the negative electrode mixture molded body in which the relationship between L and b and the value of the aspect ratio A of the conductive assistant particles were appropriate exhibited a large discharge capacity and excellent output characteristics.

In contrast, the all-solid-state secondary battery of Comparative Example 1 produced using the negative electrode that included the negative electrode mixture molded body in which the relationship between L and b and the value of the aspect ratio A of the conductive assistant particles were inappropriate exhibited a smaller discharge capacity and lower output characteristics than those of the batteries of Examples 1 and 2.

The invention may be embodied in other forms without departing from the essential characteristics thereof. The embodiments disclosed in this application are to be considered in all respects as illustrative and not limiting. The scope of the present invention should be construed primarily in view of the appended claims, rather than the foregoing description, and all changes that come within the meaning and range of equivalency of the claims are intended to be embraced therein.

### INDUSTRIAL APPLICABILITY

The all-solid-state battery according to the present invention has a large capacity and excellent output characteristics. Accordingly, the all-solid-state battery of the present invention can be preferably used in applications where the above-described characteristics are required, and is also applicable to other applications where conventionally known all-solid-state batteries are used.

### DESCRIPTION OF REFERENCE NUMERALS

1, 100 All-solid-state battery
10 Positive electrode
20 Negative electrode
30 Solid electrolyte layer
40 Exterior can
50 Sealing can
60 Gasket
200 Electrode body
300 Positive electrode external terminal
400 Negative electrode external terminal
500 Laminate-film exterior body

1. An all-solid-state battery electrode comprising:
a molded body formed from an electrode mixture that contains an electrode active material, a solid electrolyte, and conductive assistant particles,
wherein, where a number-based average particle size of the conductive assistant particles is represented by D(μm), a number-based average cross-sectional area of the conductive assistant particles is represented by s (μm²), an aspect ratio of the conductive assistant particles is represented by A, and an average inter-centroid distance of the conductive assistant particles is represented by 1 (μm), which are determined by observing a cross section of the molded body of the electrode mixture,
the conductive assistant particles satisfy A≥1.5, and
an inter-particle distance L (μm) of the conductive assistant particles in a three-dimensional space calculated from (1.22×D×l²)^{1/3} and a length b(μm) of a long axis of the conductive assistant particles calculated from 1.27×(A×s/π)^{0.5} satisfy the following relationship: L≤b.

2. The all-solid-state battery electrode according to claim 1,
wherein the electrode active material is a monoclinic niobium composite oxide represented by the following general formula (1):
MₓAl_{1-1.5x}Nb_{11+0.5x}O_{29-δ} (1),
where M represents at least one element selected from Zn and Cu, and x and δ satisfy 0≤x≤0.4 and 0≤δ≤3.

3. The all-solid-state battery electrode according to claim 1,
wherein the number-based average particle size D is 0.01 to 0.23 μm.

4. The all-solid-state battery electrode according to claim 1,
wherein a ratio of S relative to Sₜₒₜ is 0.02 to 0.1, where a total cross-sectional area of the conductive assistant particles determined by observing a cross section of the molded body of the electrode mixture is represented by S, and an area of an observed range of the cross section is represented by Sₜₒₜ (μm²).

5. The all-solid-state battery electrode according to claim 1,
the conductive assistant particles have a circularity C determined by observing a cross section of the molded body of the electrode mixture of 0.3 or more and less than 1.

6. The all-solid-state battery electrode according to claim 1, comprising:
a sulfide-based solid electrolyte as the solid electrolyte.

7. The all-solid-state battery electrode according to claim 1,
wherein the electrode mixture does not contain a binder, or contains a binder in an amount of 6 mass % or less.

8. An all-solid-state battery comprising:
a positive electrode;
a negative electrode; and
a solid electrolyte layer interposed between the positive electrode and the negative electrode,
wherein at least one of the positive electrode and the negative electrode is the all-solid-state battery electrode according to claim 1.
